(19) United States
(12) Patent Application Publication
(10) Pub. No.: US 2012/0238687 A1
(43) Pub. Date: Sep. 20, 2012

(54) RESIN COMPOSITION AND LIGHTING FIXTURE COMPONENT MADE OF THE SAME

(75) Inventor: Kenji ATARASHI, Ichihara-shi (JP)

(73) Assignee: SUMITOMO CHEMICAL COMPANY, LIMITED, Tokyo (JP)

(21) Appl. No.: 13/415,134

(22) Filed: Mar. 8, 2012

(30) Foreign Application Priority Data
Mar. 15, 2011 (JP) 2011-056201

(51) Int. Cl. C08L 23/12; C08K 3/04

(52) U.S. Cl. 524/496

(57) ABSTRACT

Disclosed is a resin composition comprising from 40% by mass to 65% by mass of a thermoplastic resin (A), from 5% by mass to 10% by mass of carbon fibers (B), and from 30% by mass to 50% by mass of graphite particles (C) having an average particle diameter of larger than 12 μm and up to 50 μm where the total amount of the thermoplastic resin (A), the carbon fibers (B), and the graphite particles (C) shall be 100% by mass, wherein the melt flow rate measured at 230° C. and under a load of 2.16 kg in accordance with JIS-K-7210 is from 0.5 g/10 minutes to 30 g/10 minutes. A lighting fixture component made of the resin composition is also disclosed.

### BACKGROUND OF THE INVENTION

1. Field of the Invention

The present invention relates to a resin composition and a lighting fixture component made of the same.

2. Description of Related Art

Heat sinks made of an aluminum-based alloy high in heat conductivity or the like have heretofore been used as heat radiating parts of LED elements to be used for LED lighting fixtures. In recent years, in order to afford heat radiating parts which are easy to fabricate and lighter, replacement of aluminum-based, alloys by resins have been studied.

For example, patent document 1 discloses a thermoplastic resin composition in which a thermoplastic resin has been filled with highly thermally conductive inorganic fiber and highly thermally conductive inorganic powder.

Patent document 2 discloses a heat releasable resin composition comprising graphite particles and a carbon fiber construction in an amount of from 10 parts by mass to 300 parts by mass of and in an amount of from 1 part by mass to 80 parts by mass, respectively, relative to 100 parts by weight of a thermoplastic resin.

### RELATED ART DOCUMENTS

### Patent Documents

[Patent Document 1] JP 8-283456 A

[Patent Document 2] JP 2008-150595 A

### PROBLEMS TO BE SOLVED BY THE INVENTION

However, the resin compositions disclosed in patent documents 1 and 2 are not satisfactory with respect to molding processability and the heat conductivity of molded articles obtained from the resin compositions is not satisfactory.

In the case of using carbon fibers as heat conductive fibers, increase in the content of carbon fibers has made it difficult to mix them with a thermoplastic resin uniformly or has raised a problem in production that, in a process of melt kneading using a plasticizing machine such as an extruder, the rate of discharge from the plasticizing machine becomes unstable.

In light of the aforementioned problems, the object of the present invention is to provide a resin composition with good thermal conductivity and good molding processability while reducing the content of carbon fiber.

### SUMMARY OF THE INVENTION

The present invention provides a resin composition comprising from 40% by mass to 65% by mass of a thermoplastic resin (A), from 5% by mass to 10% by mass of carbon fibers (B), and from 30% by mass to 50% by mass of graphite particles (C) having an average particle diameter of larger than 12 μm and up to 50 μm where the total amount of the thermoplastic resin (A), the carbon fibers (B), and the graphite particles (C) shall be 100% by mass, wherein the melt flow rate of the resin composition measured at 230° C. under a load of 2.16 kg in accordance with JIS K7210 is from 0.5 g/10 minutes to 30 g/10 minutes, and a lighting fixture component made of the resin composition.

According to the present invention, it becomes possible to provide a resin composition having good thermal conductivity and good molding processability while reducing the content of carbon fiber.

### DESCRIPTION OF THE PREFERRED EMBODIMENTS

The heat releasable resin composition according to the present invention comprises a thermoplastic resin (A), carbon fibers (B), and graphite particles (C). A detailed description is made below.

### [Resin Composition]

### <Thermoplastic Resin (A)>

The thermoplastic resin (A) contained in the resin composition is preferably a thermoplastic resin that can be fabricated at temperatures of from 200° C. to 450° C. Specific examples of thermoplastic resins preferred for the present invention include polyolefin, polystyrene, polyamide, vinyl halide resins, polyacetal, polyester, polycarbonate, polyarylsulfone, polyaryl ketone, polyphenylene ether, polyphenylene sulfide, polyaryl ether ketone, polyethersulfone, polyphenylene sulfide sulfone, polyarylate, liquid crystal polyester, and fluororesin. These may be used singly or two or more of them may be used in combination.

Among these, use of polyolefin or polystyrene is preferred from the viewpoint of molding processability, whereby molding processability in fabricating electric/electronic parts of relatively complicated shapes becomes good.

Examples of the polyolefin resin to be used preferably in the present invention include polypropylene, polyethylene, and α-olefin resins composed mainly of an α-olefin having 4 or more carbon atoms. These may be used singly or two or more of them may be used in combination.

Examples of the polypropylene include propylene homopolymers, propylene-ethylene random copolymers, and propylene-ethylene block copolymers obtainable by homopolymerizing propylene and then copolymerizing ethylene and propylene.

Examples of the polyethylene resin include ethylene homopolymers, and ethylene-α-olefin random copolymers, which are copolymers of ethylene with an α-olefin having 4 or more carbon atoms.

Examples of the α-olefin resins include α-olefin-propylene random copolymers.

Examples of the α-olefin having 4 or more carbon atoms to be used for polyolefin include 1-butene, 2-methyl-1-propene, 2-methyl-1-butene, 3-methyl-1-butene, 1-hexene, 2-ethyl-1-butene, 2,3-dimethyl-1-butene, 1-pentene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, and 1-dodecene. 1-Butene, 1-pentene, 1-hexene and 1-octene are preferred.

Examples of the method for polymerizing an olefin include bulk polymerization, solution polymerization, slurry polymerization, and vapor phase polymerization. The bulk polymerization is a method in which polymerization is carried out using, as a medium, an olefin that is liquid at the polymerization temperature, and the solution polymerization or the slurry polymerization is a method in which polymerization is carried out in an inert hydrocarbon solvent such as propane, butane, isobutane, pentane, hexane, heptane, and octane. The gas phase polymerization is a method in which a gaseous monomer is used as a medium and a gaseous monomer is polymerized in the medium.

Such polymerization methods may be conducted either in a batch system or in a continuous system and also may be conducted either in a single stage system using one polymerization reactor or in a multistage system using a polymerization apparatus composed of a plurality of polymerization reactors linked in series and these polymerization methods may be combined appropriately. From the industrial and economical points of view, a continuous vapor phase polymerization method or a bulk-vapor phase polymerization method in which a bulk polymerization method and a vapor phase polymerization method are used continuously is preferred.

The conditions in the polymerization step (e.g., polymerization temperature, polymerization pressure, monomer concentration, input amount of catalyst, and polymerization time) may be determined appropriately.

Examples of the catalyst to be used for the production of the polyolefin include multisite catalysts and single site catalysts. Examples of preferable multisite catalysts include catalysts which are obtained by use of a solid catalyst component comprising a titanium atom, a magnesium atom and a halogen atom, and examples of preferable single site catalysts include metallocene catalysts.

In the case that the polyolefin to be used in the present invention is a polypropylene, examples of preferable catalysts to be used for the method for producing the polypropylene include a catalyst that is obtained by using the aforementioned solid catalyst component comprising a titanium atom, a magnesium atom, and a halogen atom.

The propylene homopolymer and the propylene homopolymer portion (i.e., the portion formed by homopolymerization of propylene) of the propylene-ethylene block copolymer preferably has an isotactic pentad fraction, measured by ¹³C-NMR, of not less than 0.95, and more preferably not less than 0.98.

The isotactic pentad fraction is the molar fraction of propylene monomer units located at the centers of isotactic sequences in pentad units in a propylene polymer molecule chain, in other words, the fraction of propylene monomer units located in sequences in which five successively meso-bonded propylene monomer units (hereinafter represented by mmmm). The method for measuring the isotactic pentad fraction is the method disclosed by A. Zambelli et al. in Macromolecules 6, 925 (1973), namely, a method in which the measurement is performed by using ¹³C-NMR.

Specifically, the isotactic pentad fraction is a ratio of the area of the peak assigned to the mmmm to the total peak area in the methyl carbon ranges observed in a ¹³C-NMR spectrum.

From the viewpoint of the balance between the injection moldability and the heat conductivity of the resin composition, the melt flow rate (MFR) of the thermoplastic resin (A) is preferably from 10 g/10 minutes to 200 g/10 minutes, more preferably from 20 g/10 minutes to 150 g/10 minutes, and even more preferably from 20 g/10 minutes to 130 g/10 minutes. The measurement was conducted at a temperature of 230° C. under a load of 2.16 kg. The measurement of the melt flow rate (MFR) in the present invention is carried out in accordance with the method provided in JIS K7210.

From the viewpoint of the balance between the flowability and the heat conductivity of the resin composition, the content of the thermoplastic resin (A) in the present invention is from 40% by mass to 65% by mass, and preferably from 45% by mass to 55% by mass.

### <Carbon Fibers (B)>

The carbon fibers (B) to be used in the present invention are preferably a pitch-based carbon fibers having a heat conductivity exceeding 100 W/mK. Specific examples thereof include DIALEAD (registered trademark) produced by Mitsubishi Plastics, Inc. and Raheama (registered trademark) produced by Teijin, Ltd.

The surface of the carbon fibers (B) may have been treated with a converging agent. Examples of the converging agent include polyolefin, polyurethane, polyester, acrylic resins, epoxy resins, starch, and vegetable oil. In the converging agent may have been blended a surfacing agent such as an acid-modified polyolefin and a silane-based coupling agent, or a lubricant such as paraffin wax.

Examples of the method for treating the carbon fibers (B) with a converging agent include a method in which the fibers are immersed in an aqueous solution in which the converging agent has been dissolved and a method in which the aqueous solution is applied to the fibers with a spray.

The number average fiber length of the carbon fibers (B) in the resin composition in the present invention is preferably 0.5 mm or more, and more preferably 0.7 mm or more. Adjustment of the fiber length to within such a range can increase the heat conductivity. The number average fiber length (unit: mm) of carbon fibers can measured by removing resin from a sample for evaluation by a Soxhlet extraction method (solvent: xylene) to collect fibers and then carrying out measurement by the method disclosed in JP 2002-5924 A.

The diameter of the carbon fibers (B) is preferably 5 μm or more.

The content of the carbon fibers (B) is from 5% by mass to 10% by mass and preferably from 7% by mass to 9% by mass. By adjusting the content of the carbon fibers to 5% by mass or more, it becomes possible to improve the heat conductivity of a molded article to be obtained, and by adjusting the content to 10% by mass or less, it is possible to obtain a sufficient heat conductivity while reducing the content of the carbon fibers (B).

### <Graphite Particles (C)>

Graphite that constitutes the graphite particles (C) to be used in the present invention may be either of artificial graphite or of natural graphite. Specific examples include CB-150 (trademark) produced by Nippon Graphite Industries, Co., Ltd.

The average particle diameter of the graphite particles (C) is greater than 12 μm and up to 50 μm, and preferably from 19 μm to 40 μm. If the average particle diameter is less than 12 μm, the flowability of the resin composition will decrease, whereby the molding processability will deteriorate.

The average particle diameter can be measured by using a laser scattering particle size distribution analyzer.

The content of the graphite particles (C) is from 30% by mass to 50% by mass and preferably from 35% by mass to 45% by mass. By adjusting the content of the graphite particles (C) to 30% by mass or more, it becomes possible to improve the sufficient heat conductivity of a molded article to be obtained, and by adjusting the content to 50% by mass or less, it is possible to obtain a resin composition with good molding processability.

### <Organic Fibers (D)>

The resin composition to be used in the present invention may contain organic fibers (D). Examples of the organic fiber include polyester fiber, polyamide fiber, polyurethane fiber, polyimide fiber, polyolefin fiber, polyacrylonitrile fiber, and vegetable fiber such as kenaf. In particular, when the thermoplastic resin (A) is polyolefin, it is preferred that the resin composition contain organic fibers and use of polyester fiber is preferred.

In the present invention, the organic fiber is preferably used in the form of an organic fiber-containing resin composition in which the above-described thermoplastic resin (A) or a resin such as a modified polyolefin modified with an unsaturated carboxylic acid or a derivative and elastomer has been mixed. Examples of the method for producing an organic fiber-containing resin composition include the methods disclosed in JP 2006-8995A and JP 3-121146 A. The content of the organic fibers in the organic fiber-containing resin composition is preferably from 10% by mass to 60% by mass. In the case that an organic fiber-containing resin composition is produced using the thermoplastic resin according to the present invention or a modified polyolefin, the amount used thereof is incorporated into the content of the thermoplastic resin according to the present invention (from 40% by mass to 65% by mass).

The content of the organic fibers as an optional component in the resin composition in the present invention is preferably from 3 parts by mass to 10 parts by mass and preferably from 3 parts by mass to 5 parts by mass relative to 100 parts by mass of the thermoplastic resin (A), the carbon fibers (B) and the graphite particles (C) in total.

### <Modifier (E)>

The resin composition to be used in the present invention may contain modifiers such as those described below (E). Examples of such modifiers include modified polyolefin modified with an unsaturated carboxylic acid or a derivative thereof, which is generally used for strengthen bonding between a thermoplastic resin and an inorganic component.

Other examples include glass fiber, talc, wollastonite, and glass flake. In order to improve the processing characteristics, mechanical characteristics, electrical characteristics, thermal characteristics, surface characteristics, and stability to light, various types of additives may be incorporated. Examples of such additives include antioxidants, neutralizers, plasticizers, lubricants, release agents, antibonding agents, heat stabilizers, light stabilizers, flame retardants, pigments, and dyes.

### <Method for Producing a Resin Composition>

The method for producing of a resin composition is not particularly restricted, and one example thereof is a method in which a thermoplastic resin (A), carbon fibers (B), graphite particles (C), organic fibers (D) to be used according to need, a modifier (E), and so on are mixed uniformly using a Henschel mixer, a tumbler, or the like and then melt kneaded by using a plasticizing machine. In the melt kneading, it is preferred to adjust the temperature and agitation speed of the plasticizing machine appropriately for inhibiting the carbon fibers (B) from breaking to become too short.

Especially when adding organic fibers, it is also permitted to prepare a resin composition containing organic fibers beforehand by, for example, the method disclosed in JP 2006-8995 A, then uniformly mix the resin composition with a thermoplastic resin, carbon fibers, a modified polyolefin, and a filler/additive to be used according to need by using a Henschel mixer, a tumbler, or the like, and then conduct melt kneading using a plasticizing machine.

In conducting melt kneading by using a plasticizing machine, it is also permitted to feed the above-mentioned respective components through the same feed port or separate feed ports and further feed a rubber, such as a polyolefin-based elastomer, a polyester-based elastomer, a polyurethane-based elastomer, and a PVC-based elastomer, and so on, thereby making a resin composition contain them. The plasticizing machine as used herein is a device by which a thermoplastic resin is heated to a temperature equal to or higher than the melting point thereof and apply agitation to the thermoplastic resin being in a molten state. Examples thereof include a Banbury mixer, a single screw extruder, a twin screw co-rotating extruder (e.g., TEM [registered trademark] manufactured by Toshiba Machine Co., Ltd., TEX [registered trademark] manufactured by Japan Steel Works, Ltd.), and a twin screw counter-rotating extruder (e.g., FCM [registered trademark] manufactured by Kobe Steel, Ltd. and CMP [registered trademark] manufactured by The Japan Steel Works, Ltd.).

The melt flow rate of the resin composition according to the present invention is from 0.5 g/10 minutes to 30 g/10 minutes, preferably from 0.5 g/10 minutes to 25 g/10 minutes, and more preferably from 1 g/10 minutes to 15 g/10 minutes. If the melt flow rate is less than 0.5 g/10 minutes, the molding processability will be inferior. If the melt flow rate exceeds 30 g/10 minutes, appearance anomaly of the surface of a molded article, which is called void, may be generated in injection molding or leakage of resin from the nozzle of an injection molding machine, which is called salivation, may occur.

As the melt flow rate, a value measured at 230° C. under a load of 2.16 kg in accordance with JIS-K-7210 is used.

### [Lighting Fixture Component]

The lighting fixture component according to the present invention is obtained by molding the above-described resin composition. The molding method is not particularly restricted and molding can be conducted by using a technique, for example, extrusion molding, injection molding, compression molding, or blow molding.

Examples of the lighting fixture component include heat radiating parts such as a heat sink, ceiling covers, and lampshades.

### EXAMPLES

The present invention is illustrated below with reference to examples, but the invention is not limited to the examples.

### (1) Resin Composition

The following components were used for resin compositions.

Thermoplastic Resin (A):

(A-1): Propylene-ethylene block copolymer that is obtained by homopolymerizing propylene and then randomly copolymerizing ethylene and propylene (melt flow rate (MFR): 5 g/10 minutes, isotactic pentad fraction of a propylene homopolymer portion=0.98, the content of a propylene-ethylene random copolymer portion in a propylene-ethylene block copolymer: 12% by mass)

(A-2): Propylene-ethylene block copolymer that is obtained by homopolymerizing propylene and then randomly copolymerizing ethylene and propylene (MFR: 20 g/10 minutes, isotactic pentad fraction of a propylene homopolymer portion=0.98, the content of a propylene-ethylene random copolymer portion in a propylene-ethylene block copolymer: 12% by mass)

(A-3): Propylene-ethylene block copolymer that is obtained by homopolymerizing propylene and then randomly copolymerizing ethylene and propylene (MFR: 50 g/10 minutes, isotactic pentad fraction of a propylene homopolymer portion=0.98, the content of a propylene-ethylene random copolymer portion in a propylene-ethylene block copolymer: 12% by mass)

(A-4): Propylene-ethylene block copolymer that is obtained by homopolymerizing propylene and then randomly copolymerizing ethylene and propylene (MFR: 130 g/10 minutes, isotactic pentad fraction of a propylene homopolymer portion=0.98, the content of a propylene-ethylene random copolymer portion in a propylene-ethylene block copolymer: 12% by mass)

The content (X) of the propylene-ethylene random copolymer portion in the propylene-ethylene block copolymer was determined by measuring the heat of crystal fusion of the propylene homopolymer portion and that of the whole portion of the propylene-ethylene block copolymer and then calculating the content by using the following formula. The heat of crystal fusion was measured by differential scanning calorimetry (DSC).

X=1−(ΔHf)T/(ΔHf)P

(ΔHf)T: heat of fusion (cal/g) of the block copolymer

(ΔHf)P: Heat of fusion (cal/g) of the propylene homopolymer portion

Carbon Fiber (B):

DIALEAD (registered trademark) K223HE produced by Mitsubishi Plastics, Inc.; the number average fiber length=6 mm, the diameter=11 μm, the heat conductivity=550 W/mK

Graphite Particle (C):

(C-1): CB-150 (registered trademark) produced by Nippon Graphite Industries, Co., Ltd., fixed carbon amount >98%, average particle diameter=40 μm

(C-2): CPB (registered trademark) produced by Nippon Graphite Industries, Co., Ltd., fixed carbon amount >97%, average particle diameter=19 μm

(C-3): CSP (registered trademark) produced by Nippon Graphite Industries, Co., Ltd., fixed carbon amount >97%, average particle diameter=12 μm

Modifier (E):

For the purpose of reinforcing the interface of carbon fibers, graphite particles, and thermoplastic resin, maleic anhydride-modified polypropylene (E-1) (MFR=70 g/10 minutes, grafted maleic anhydride amount=0.6% by mass) in the amount given in Table 1 was used based on 100 parts by mass of the thermoplastic resin (A), carbon fibers (B), and graphite particles (C) in total.

The maleic anhydride-modified polypropylene was prepared in accordance with the method disclosed in Example 1 of JP 2004-197068 A. As the content of the monomer units derived from an unsaturated carboxylic acid and/or an unsaturated carboxylic acid derivative, used was a value calculated based on a measurement of the absorption based on the unsaturated carboxylic acid and/or the unsaturated carboxylic acid derivative by an infrared absorption spectrum or an NMR spectrum.

The following antioxidants or additives were used in the contents given in Table 1. The contents are values expressed where the total amount of the thermoplastic resin (A), the carbon fibers (B) and the graphite particles (C) shall be 100 parts by mass.

(E-2): Commercial name: SUMILIZER GP (produced by Sumitomo Chemical Co., Ltd.)

(E-3): Commercial name: IRGANOX 1010 (produced by GE Specialty Chemicals)

(E-4): Hydrotalcite, produced by Kyowa Chemical Industry Co., Ltd., commercial name: DHT-4C

### [Evaluation of Physical Properties]

Evaluation items of the molded articles produced in examples and comparative examples and the measuring methods thereof are as follows.

The results of the evaluations are shown in Table 2.

(1) Melt Flow Rate (MFR; Unit: g/10 Minutes)

The melt flow rate of a resin composition was measured in accordance with the method provided in JIS K7210. The measurement was performed at a temperature of 230° C. under a load of 2.16 kg.

### (2) Specific Gravity

The specific gravity of a sample was measured in accordance with A.S.T.M D792.

### (3) Heat Conductivity

The heat conductivity of a molded article was measured using a laser flash method.

Three specimens sized 80 mm×10 mm×4 mm in thickness, each set having been prepared in each of Examples and Comparative Examples, were stacked and bonded, whereby a 12-mm thick laminate was obtained. At two sites in an approximately central part of the laminate, the laminate was cut in the direction perpendicular to the bonded surfaces and each cut section was polished, whereby a specimen sized 10 mm×12 mm×1 mm in thickness was prepared.

Using this specimen, the heat conductivity of the molded article in the in-plane direction (the direction perpendicular to the bonded surface) was measured by a laser flash thermal constants analyzer (TC-7000 manufactured by ULVAC Technologies, Inc.).

### (4) Flexural Modulus (FM, Unit: MPa)

Using a specimen (4 mm in thickness) prepared by injection molding pellets, evaluation was conducted at a span length of 100 mm, a width of 10 mm, a loading speed of 2.0 mm/min, 23° C. in accordance with the method provided in JIS K7171.

(5) Izod Impact Strength (Izod, Unit: kJ/cm²)

Using a specimen (4 mm in thickness) prepared by injection molding pellets, the specimen was notched after molding in accordance with the method provided in JIS K7110, and the notched impact strength was evaluated. The measuring temperature was 23° C.

### Examples 1 to 7, Comparative Examples 1 to 7

The above-mentioned thermoplastic resin (A), carbon fibers (B), graphite particles (C), and modified polypropylene (F-1) in the proportions given in Table 1 and the antioxidant in the above-mentioned proportion were put into a polyethylene bag, mixed uniformly by shaking vigorously, and then melt kneaded at a cylinder temperature of 240° C. by using a 20-mm single screw extruder VS20-26 manufactured by Tanabe Plastics Machinery Co., Ltd., followed by cutting into a pellet form of about 3 mm in length, whereby a resin composition was produced.

Particularly, in Comparative Example 4 and Comparative Example 5, in which large amounts of carbon fibers were used, discharge from the extruder was unstable and therefore the production was difficult.

Subsequently, the resulting pellets were subjected to injection molding at a cylinder temperature of 230° C., a mold temperature of 50° C., an injection speed of 20 mm/second, and a holding pressure of 25 MPa by using an injection molding machine (TOYO SI-301II, manufactured by Toyo Seiki Seisaku-sho, Ltd.), so that specimens for evaluation were obtained. The results are shown in Table 2.

TABLE 1

| | | Example | | | | | | |
|---|---|---|---|---|---|---|---|---|
| | | 1 | 2 | 3 | 4 | 5 | 6 | 7 |
| Thermo- | Kind | A-4 | A-4 | A-4 | A-3 | A-4 | A-3 | A-4 |
| plastic | Mass % | 50 | 47 | 47 | 49 | 47 | 47 | 50 |
| resin (A) | | | | | | | | |
| Carbon | Mass % | 10 | 10 | 8 | 6 | 8 | 8 | 10 |
| fiber (B) | Vol. % | 5.9 | 6.0 | 4.8 | 3.5 | 4.8 | 4.8 | 5.9 |
| Graphite | Kind | C-1 | C-1 | C-1 | C-1 | C-1 | C-1 | C-2 |
| particle | Mass % | 40 | 43 | 45 | 45 | 45 | 45 | 40 |
| (C) | Vol. % | 23.4 | 25.8 | 27.0 | 26.6 | 27.0 | 27.0 | 23.4 |
| Filler | E-1 Part | 1 | 1 | 1 | — | 1 | 1 | 1 |
| (E) | by mass | | | | | | | |
| | E-2 Part | 0.1 | 0.1 | 0.1 | 0.1 | 0.1 | 0.1 | 0.1 |
| | by mass | | | | | | | |
| | E-3 Part | 0.1 | 0.1 | 0.1 | 0.1 | 0.1 | 0.1 | 0.1 |
| | by mass | | | | | | | |
| | E-4 Part | 0.01 | 0.01 | 0.01 | 0.01 | 0.01 | 0.01 | 0.01 |
| | by mass | | | | | | | |

| | | Comparative Example | | | | | | |
|---|---|---|---|---|---|---|---|---|
| | | 1 | 2 | 3 | 4 | 5 | 6 | 7 |
| Thermo- | Kind | A-4 | A-4 | A-4 | A-4 | A-4 | A-1 | A-4 |
| plastic | Mass % | 100 | 60 | 80 | 60 | 50 | 47 | 50 |
| resin (A) | | | | | | | | |
| Carbon | Mass % | — | — | — | 40 | 50 | 8 | 10 |
| fiber (B) | Vol. % | — | — | — | 21.6 | 29.3 | 4.8 | 5.9 |
| Graphite | Kind | — | C-1 | C-1 | — | — | C-1 | C-3 |
| particle | Mass % | — | 40 | 20 | — | — | 45 | 40 |
| (C) | Vol. % | — | 21.6 | 9.4 | — | — | 27.0 | 23.4 |
| Filler | E-1 Part | — | 1 | 1 | — | 1 | 1 | 1 |
| (E) | by mass | | | | | | | |
| | E-2 Part | 0.1 | 0.1 | 0.1 | 0.1 | 0.1 | 0.1 | 0.1 |
| | by mass | | | | | | | |
| | E-3 Part | 0.1 | 0.1 | 0.1 | 0.1 | 0.1 | 0.1 | 0.1 |
| | by mass | | | | | | | |
| | E-4 Part | 0.01 | 0.01 | 0.01 | 0.01 | 0.01 | 0.01 | 0.01 |
| | by mass | | | | | | | |

TABLE 2

| | | Heat | | | |
|---|---|---|---|---|---|
| | Specific | conductivity | MFR | FM | Izod |
| | gravity | W/mK | g/10 minutes | MPa | kJ/m² |
| Example 1 | 1.28 | 9.7 | 7 | 4920 | 2 |
| Example 2 | 1.31 | 11.6 | 5 | 5050 | 1.9 |
| Example 3 | 1.32 | 10.6 | 5 | 4900 | 1.8 |
| Example 4 | 1.29 | 10.6 | 2.7 | 4390 | 2.1 |
| Example 5 | 1.32 | 11.3 | 0.5 | 4480 | 2.4 |
| Example 6 | 1.32 | 11.7 | 1.3 | 4960 | 2.1 |
| Example 7 | 1.29 | 9.5 | 1 | 4610 | 2 |
| Comparative | 0.91 | 0.2 | 128 | 1200 | 2.9 |
| Example 1 | | | | | |
| Comparative | 1.19 | 3.2 | 31 | 3980 | 1.7 |
| Example 2 | | | | | |
| Comparative | 1.03 | 1.2 | 71 | 2780 | 1.8 |
| Example 3 | | | | | |
| Comparative | 1.17 | 11.2 | 25 | 6080 | 2.9 |
| Example 4 | | | | | |
| Comparative | 1.27 | 12.4 | 17 | 6420 | 2.9 |
| Example 5 | | | | | |
| Comparative | 1.32 | 8.8 | 0.1 | 3180 | 3.7 |
| Example 6 | | | | | |
| Comparative | 1.29 | 9.6 | 0.4 | 4630 | 1.9 |
| Example 7 | | | | | |

In Examples 1 to 7, which satisfy the requirements of the present invention, flowability high enough for molding and a high heat conductivity are attained at carbon fiber contents of up to 10% by mass. In Comparative Example 1 without carbon fibers and graphite particles, the heat conductivity is low. In Comparative Examples 2 and 3 without carbon fibers, sufficient heat conductivities are not attained. In Comparative Examples 4 and 5 without graphite particles, the heat conductivity and the flowability are sufficient, but production is difficult. In Comparative Example 7 in which the average particle diameter of graphite particles is not greater than 12 μm, sufficient flowability was not attained.

1. A resin composition comprising from 40% by mass to 65% by mass of a thermoplastic resin (A), from 5% by mass to 10% by mass of carbon fibers (B), and from 30% by mass to 50% by mass of graphite particles (C) having an average particle diameter of larger than 12 μm and up to 50 μm where the total amount of the thermoplastic resin (A), the carbon fibers (B), and the graphite particles (C) shall be 100% by mass, wherein the melt flow rate measured at 230° C. and under a load of 2.16 kg in accordance with JIS-K-7210 is from 0.5 g/10 minutes to 30 g/10 minutes.

2. The resin composition according to claim 1, wherein the thermoplastic resin is polypropylene.

3. A lighting fixture component made of the resin composition according to claim 1.

4. A lighting fixture component made of the resin composition according to claim 2.
